(19) United States
(12) Patent Application Publication
(10) Pub. No.: US 2014/0160241 A1
(43) Pub. Date: Jun. 12, 2014

(54) SYSTEM AND METHOD FOR ENCODING AND DECODING A BITSTREAM FOR A 3D MODEL HAVING REPETITIVE STRUCTURE

(71) Applicants: Kangying Cai, Beijing (CN); Wenfei Jiang, Beijing (CN); Jiang Tian, Beijing (CN)

(72) Inventors: Kangying Cai, Beijing (CN); Wenfei Jiang, Beijing (CN); Jiang Tian, Beijing (CN)

(21) Appl. No.: 14/131,325

(22) PCT Filed: Jul. 6, 2012
(86) PCT No.: PCT/CN2012/078301

§ 371 Date: Jan. 7, 2014

(30) Foreign Application Priority Data
Jul. 8, 2011 (CN) PCT/CN2011/076991

(51) Int. Cl. H04N 13/00; H04L 29/06

(52) U.S. Cl. CPC H04N 13/0048; H04L 65/607
USPC 348/43

(57) ABSTRACT

Typically, 3D meshes are represented by three types of data: connectivity data, geometry data and property data. An encoded 3D mesh model can be represented, transmitted and/or stored as a bitstream. While the bitstream embeds all the transformation data, it is efficient and may address several applications, where sometimes either bitstream size or decoding efficiency or error resilience matters the most. Therefore, two mode options are disclosed for how to put the transformation data of one instance, i.e. its position, orientation and scaling factor, in the bitstream. In the first mode, the position, orientation and possible scaling factor of one instance are packed together in the bitstream. In the second mode, transformation data types, for example, the positions, orientations or possible scaling factors of all instances are packed together according to the data type in the bitstream.

### FIELD OF THE INVENTION

This invention relates to a bitstream syntax and semantics of repetitive structure discovery based 3D model compression algorithm, a method and an apparatus for encoding the same, and a method and an apparatus for decoding the same.

### BACKGROUND

In practical applications, many 3D models consist of a large number of connected components. And these multi-connected 3D models usually contain lots of repetitive structures in various transformations, as shown in FIG. 1. Efficient compression methods for this kind of 3D models should be able to extract the redundancy existing in the repetitive structures.

An efficient compression algorithm for multi-connected 3D models, by taking advantage of discovering repetitive structures in the input models, was proposed in “Efficient Compression Scheme for Large 3D Engineering Models,” WO 2010149492, filed Jun. 9, 2010, and assigned to Thomson Licensing, and whose teachings are incorporated herein by reference. It discovers the structures repeating in various positions, orientations and scaling factors. Then the 3D model is organized into a “pattern-instance” representation. A pattern is the representative geometry of the corresponding repetitive structure. The connected components belonging to a repetitive structure are called instances of the corresponding pattern and are represented by their transformation, i.e. the positions, orientations and possible scaling factors, regarding to the pattern. The orientation of an instance is represented by two orthogonal axes represented by (x0, y0, z0) and (x1, y1, z1) in a Cartesian coordinate system, or (alpha, beta, gamma) in a spherical coordinate system.

### Invention

A compressed bitstream syntax and semantics is disclosed that relates to a repetitive structure discovery based compression algorithm, which has been proven to be more efficient than the static 3D model compression algorithms provided by MPEG-3DGC. The disclosed compressed bitstream syntax and semantics of our repetitive structure discovery based compression algorithm is applicable, for example, to MPEG.

The present invention is about the compressed bitstream syntax and semantics.

The present invention also provides a system and a method for encoding and decoding a bitstream for a 3D model having repetitive structures.

An apparatus that utilizes the method is disclosed below.

The present invention also provides a computer readable medium having executable instructions to cause a computer to perform a method comprising corresponding steps for encoding or decoding a bitstream for a 3D model having repetitive structures.

FIG. 1 shows exemplary 3D models with a large number of connected components and repetitive structures;

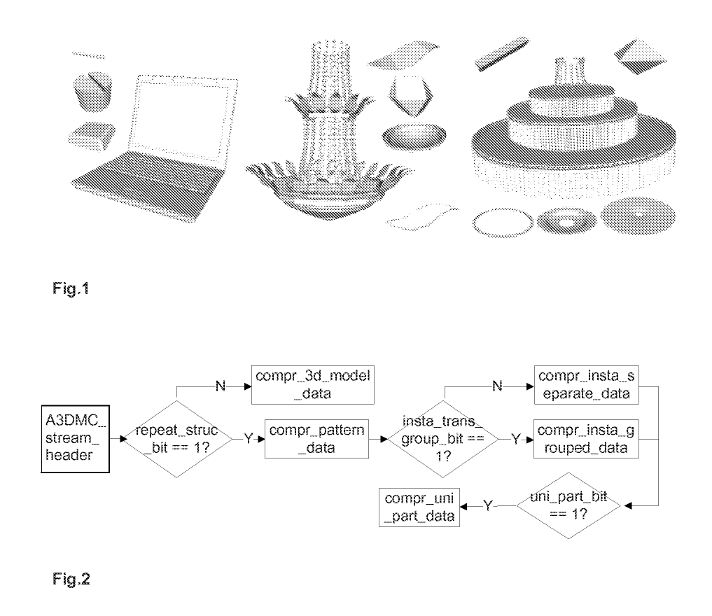

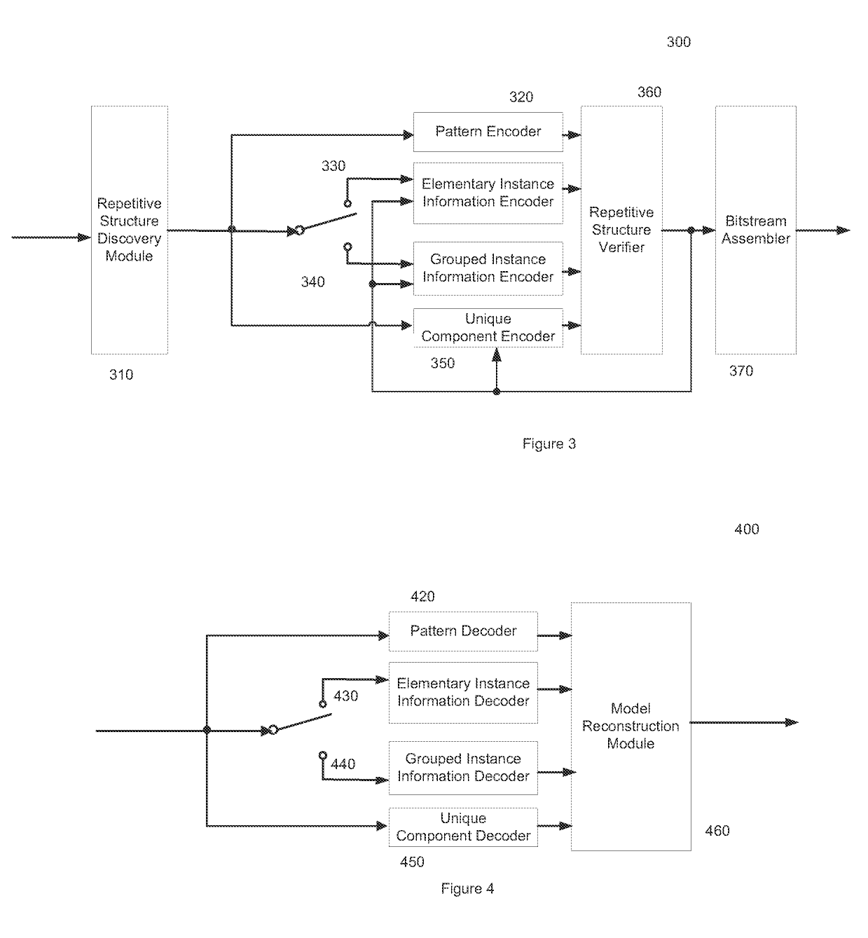

FIG. 2 shows a method for processing a structure of a 3DMC compressed bitstream according to the invention;

FIG. 3 shows an exemplary encoder of 3D models according to the present principles; and

FIG. 4 shows an exemplary decoder of 3D models according to the present principles.

Three-dimensional (3D) meshes are widely used in various applications for representing 3D objects, such as video games, engineering design, e-commerce, virtual reality, and architectural and scientific visualization. Usually their raw representation requires a huge amount of data. However, most applications prefer compact 3D mesh representation for storage or transmission. Typically, 3D meshes are represented by three types of data: connectivity data, geometry data and property data. Connectivity data describe the adjacency relationship between vertices, geometry data specify vertex locations, and property data specify attributes such as the normal vector, material reflectance and texture coordinates. Most 3D compression algorithms compress connectivity data and geometry data separately. The coding order of geometry data is determined by the underlying connectivity coding. Geometry data is usually compressed by three main steps: quantization, prediction and statistical encoding. 3D mesh property data are usually compressed in a similar manner.

The present invention is related to an efficient compression method for large 3D engineering models. Such models are often composed of several partitions, so-called “connected components”. The redundancy in the representation of repeating geometric feature patterns can be reduced by regarding all the connected components that are equivalent (e.g. after normalization of position, size) as instances of one geometry pattern. Equivalent components can be clustered. A cluster may refer to only some, or to all components of a 3D model. Then each connected component can be represented by an identifier, such as an alphanumeric identifier, of the corresponding geometry pattern (or clustering class) and the transformation information which can reconstruct the component from the geometry pattern. This transformation information may exemplarily comprise one or more of scale factors, mean (or center), orientation axes (or and rotation information, respectively), or shift information. In principle, also others are possible.

The encoded model can be represented, transmitted and/or stored as a bitstream.

While we want the bitstream to embed all the transformation data, we also want it to be efficient and to address several applications, where sometimes either bitstream size or decoding efficiency or error resilience matters the most.

Therefore, two options are disclosed for how to put the transformation data of one instance, i.e. its position, orientation and scaling factor, in the bitstream. Both of them have their own advantages. An adaptive combination of both is particularly advantageous.

Option (A) is called grouped instance transformation mode: Using this mode, the position, orientation and possible scaling factor of one instance are packed together in the bitstream.

Advantages of option (A) are
It is error resilient. The decoder can be recovered from losing the transformation of some instances.
On-line decoding. That means the instances can be decoded one by one during reading the compressed bitstream. There is no need to wait for finishing reading of the whole compressed bitstream.
Higher codec speed.
The codec needs no (or only a very small) buffer.

Option (B) is called separate instance transformation mode: The positions, orientations or possible scaling factors of all instances are packed together in the bitstream. In other words, the position, orientation and possible scaling factor of one instance are packed separately in the bitstream.

Advantages of option (B) are
smaller compressed 3D model size relative to option (A).

A decoder that uses option (B) has also the following features.
The decoder is not error resilient.
Off-line decoding. That means the decoder can only start decoding after reading the whole compressed bitstream.
Lower codec speed.
Buffer is necessary.

Our bitstream definition includes both the above two options (A) and (B). Then the user, or an automatic control, can choose the one which fits their one or more applications better.

The general structure of the compressed bitstream of our repetitive structure discovery based compression algorithm, A3DMC, is as shown in FIG. 2.

The bitstream starts with the header buffer (A3DMC_stream_header), which contains all the necessary information for decoding the compressed stream: whether there is any repetitive structure in the original model, the 3D model compression method used for compressing patterns and other parts if necessary, whether the “grouped instance transformation mode” or “separate instance transformation mode” is used in this bitstream, whether there are some parts of the original model which are not included in any repetitive structure (unique part), etc.

If there is no repetitive structure in the original model (repeat_struc_bit !=1), the left part (e.g. the beginning) of the bitstream is the compressed input 3D model using the 3D model compression method indicated in A3DMC_stream_header. Otherwise, the next part in the bitstream is the compressed result of all patterns. Depending on which instance transformation packing mode is chosen in this bitstream, either compr_insta_grouped_data or compr_insta_separate_data is the next part in the bitstream. If there is unique part in the original 3D model, compr_uni_part_data is attached. Otherwise, the bitstream ends.

The compressed bitstream syntax and semantics of A3DMC, will be explained in details as follows.

### Bitstream Syntax and Semantics

### Specification of Syntax Functions, Categories, and Descriptors

f(n): fixed-pattern bit string using n bits written (from left to right). n depends on the code length for each symbol
ec(v): entropy-coded (e.g., arithmetic coded) syntax element, including possibly configuration symbols.

### A3DMC_Stream Class

TABLE 1

| class A3DMC_stream{ | Num. of Bits | Descriptor |
|---|---|---|
| A3DMC_stream_header | | |
| A3DMC_steam_data | | |
| } | | |

A3DMC_stream_header: contains the header buffer.
A3DMC_steam_data: contains the data buffer.

### A3DMC_Stream_Header Class

TABLE 2

| class A3DMC_stream_header{ | Num. of Bits | Descriptor |
|---|---|---|
| repeat_struc_bit | 1 | |
| 3d_model_compr_mode | 2 | |
| QP | 5 | |
| If(repeat_struc_bit == 1){ | | |
| pattern_num | 8 | |
| If(pattern_num == 255){ | | |
| pattern_num_2 | 16 | |
| } | | |
| instance_num | 16 | |
| If(instance_num == 65535){ | | |
| instance_num_2 | 32 | |
| } | | |
| insta_trans_group_bit | 1 | |
| insta_orient_mode_bit | 1 | cartesian / spherical |
| | | coordinate |
| use_scaling_bit | 1 | |
| uni_part_bit | 1 | |
| reserved_bits | 4 | |
| } | | |
| } | | |

repeat_struc_bit: a 1-bit unsigned integer indicating whether there are repetitive structures in the 3D model. 0 means no repetitive structure and 1 means repetitive structure.
3d_model_compr_mode: a 2-bit unsigned integer indicating the 3D model compression method used to compress patterns, unique part and the original 3D model itself if it includes no repetitive structures.

TABLE 3

| 3d_model_compr_mode | Meaning |
|---|---|
| 00 | SC3DMC |
| 01 | 3DMC Extension |
| 10 & 11 | ISO reserved |

QP: a 5-bit unsigned integer indicating the quantization parameter. E.g., the minimum value of QP is 3 and the maximum is 31.
pattern_num: a 8-bit unsigned integer indicating the number of all patterns if it is less than 255. The minimum value of pattern_num is 1.

pattern_num_{—}2: a 16-bit unsigned integer indicating the number of all patterns if it is not less than 255. In this case, the total pattern number is (pattern_num_{—}2+255)
instance_num: a 16-bit unsigned integer indicating the number of all instances if it is less than 65535. The minimum value of instance_num is 1.
instance_num_{—}2: a 32-bit unsigned integer indicating the number of all instances if it is not less than 65535. In this case, the total instance number is (instance_num_{—}2+65535)
insta_trans_group_bit: a 1-bit unsigned integer indicating whether “grouped instance transformation mode” or “separate instance transformation mode” is used in this bitstream. 0 for “separate instance transformation mode” and 1 for “grouped instance transformation mode”.
insta_orient_mode_bit: a 1-bit unsigned integer indicating the encoding mode of instance orientation. 0 means spherical mode and 1 Cartesian mode.
use_scaling_bit: a 1-bit unsigned integer indicating whether instance transformation include scaling factors. 0 for scaling factors being included in instance transformation and 1 for not.
uni_part_bit: a 1-bit unsigned integer indicates whether there is unique part in the original 3D model. 0 means there is no unique part and 1 means there is unique part.
reserved_bits: a 4-bit unsigned integer which is always 0000 and used for byte alignment.

### A3DMC_Stream_Data Class

TABLE 4

| class A3DMC_stream_data{ | Num. of bits | Descriptor |
|---|---|---|
| if (repeat_struc_bit == 1) { | | |
| compr_repeat_struc_data | | |
| } | | |
| else{ | | |
| compr_3d_model_data | | |
| } | | |
| } | | |

compr_repeat_struc_data: contains the compressed 3d model, which includes repetitive structures.
compr_3d_model_data: contains the compressed 3d model, which has no repetitive structures and is encoded by the compression method indicated by 3d_model_compr_mode.

### Compr_Repeat_Struc_Data Class

TABLE 5

| | Num. | |
|---|---|---|
| class compr_repeat_struc_data{ | of bits | Descriptor |
| compr_pattern_data | | |
| if(insta_trans_group_bit == 1){ | | |
| compr_insta_grouped_data | | |
| } | | |
| else{ | | |
| compr_insta_separate_data | | |
| } | | |
| if (uni_part_bit == 1){ | | |
| compr_uni_part_data | | |
| } | | |
| } | | |

compr_pattern_data: contains the compressed pattern data of all patterns, which is encoded by the compression method indicated by 3d_model_compr_mode.
compr_insta_grouped_data: contains the compressed instance transformation data using the “grouped instance transformation mode”.
compr_insta_separate_data: contains the compressed instance transformation data using the “separate instance transformation mode”.
compr_uni_part_data: contains the compressed unique part data, which is encoded by the compression method indicated by 3d_model_compr_mode.

### Compr_Insta_Grouped_Data Class

TABLE 6

| class compr_insta_grouped_data{ | Num. of bits | Descriptor |
|---|---|---|
| for (i = 0; i < numofInstance; i ++) { | | |
| compr_ith_insta_patternID | | ec(v) |
| compr_ith_insta_position | bit_num_insta_position( ) | f(bit_num_insta_position( )) |
| If (insta_orient_mode_bit == 1){ | | |
| compr_ith_insta_orient_cartesian | | |
| } | | |
| else{ | | |
| compr_ith_insta_orient_spherical | | |
| } | | |
| if (use_scaling_bit){ | | |
| compr_ith_insta_scaling | | ec(v) |
| } | | |
| } | | |
| } | | |

compr_ith_insta_patternID: contains the compressed pattern ID of ith instance.
compr_ith_insta_position: contains the compressed position of ith instance.
compr_ith_insta_orient_cartesian: contains the compressed orientation of ith instance in Cartesian mode.
compr_ith_insta_orient_spherical: contains the compressed orientation of ith instance in spherical mode.
compr_ith_insta_scaling: contains the compressed scaling factor of ith instance.
bit_num_insta_position( ): compute the number of bits for each instance position value based on QP.

### Compr_Ith_Insta_Orient_Cartesian Class

TABLE 7

| class compr_ith_insta_orient_cartesian{ | Num. of bits | Descriptor |
|---|---|---|
| compr_ith_insta_orient_x0 | bit_num_orient_cartesian( ) | f(bit_num_orient_cartesian( )) |
| compr_ith_insta_orient_y0 | bit_num_orient_cartesian( ) | f(bit_num_orient_cartesian( )) |
| ith_insta_orient_z0_sgn | 1 | |
| if (compute_z0( ) < threshold) { | | |
| compr_ith_insta_orient_z0_res | bit_num_orient_res_cartesian( ) | f(bit_num_orient_res_cartesian( )) |
| } | | |
| if (compute_z0( ) = 0) { | | |
| compr_ith_insta_orient_z1 | bit_num_orient_cartesian( ) | f(bit_num_orient_cartesian( )) |
| if (abs(ith_x0) < abs(ith_y0)){ | | |
| ith_insta_orient_x1_sgn | 1 | |
| }else{ | | |
| ith_insta_orient_y1_sgn | 1 | |
| } | | |
| }else { | | |
| if (abs(ith_x0) < abs(ith_y0)){ | | |
| compr_ith_insta_orient_x1 | bit_num_orient_cartesian( ) | f(bit_num_orient_cartesian( )) |
| }else { | | |
| compr_ith_insta_orient_y1 | bit_num_orient_cartesian( ) | f(bit_num_orient_cartesian( )) |
| } | | |
| ith_insta_orient_delta_sgn | 1 | |
| if (compute_z1( ) < threshold) { | | |
| compr_ith_insta_orient_z1_res | bit_num_orient_res_cartesian( ) | f(bit_num_orient_res_cartesian( )) |
| } | | |
| } | | |
| } | | |

The orientation of ith instance in Cartesian mode is represented by 2 orthogonal axes (x0, y0, z0) and (x1, y1, z1).
compr_ith_insta_orient_x0: contains the compressed x0 of i^{th} instance's orientation.
compr_ith_insta_orient_y0: contains the compressed y0 of i^{th} instance's orientation.
compr_ith_insta_orient_z0_sgn: a 1-bit unsigned integer indicating the sign of z0 needed for calculating z0 using x0 and y0. 0 for “−“ and 1 for “+”.
compr_ith_insta_orient_z0_res: contains the compressed residual of z0 which is calculated by (z0 − computer_z0( )).
compr_ith_insta_orient_z1: contains the compressed z1 of i^{th} instance's orientation.
ith_insta_orient_x1_sgn: a 1-bit unsigned integer indicating the sign of x1 needed for calculating x1 using x0, y0. 0 for “−“ and 1 for “+”.
ith_insta_orient_y1_sgn: a 1-bit unsigned integer indicating the sign of y1 needed for calculating y1 using x0, y0. 0 for “−” and 1 for “+”.
compr_ith_insta_orient_x1: contains the compressed x1 of i^{th} instance's orientation.
compr_ith_insta_orient_y1: contains the compressed y1 of i^{th} instance's orientation.
ith_insta_orient_delta_sgn: a 1-bit unsigned integer indicating the sign needed for calculating x1 or y1 using x0, y0, z0 and y1 or x1. 0 for “−” and 1 for “+”.
compr_ith_insta_orient_z1_res: contains the compressed residual of z1 which is calculated by (z1 − computer_z1( ))
threshold: a threshold widely accepted in compression field.
compute_z0( ): compute z0 of the ith instance using x0, y0 and z0 sign.
bit_num_orient_cartesian( ): compute the number of bits for each orientation value in cartesian coordinate system based on QP.
bit_num_orient_res_cartesian( ): compute the number of bits for each orientation residual value in cartesian coordinate system based on QP.
compute_z1( ): compute z1 of the ith instance using x0, y0, z0, x1 and y1.

### Compr_Ith_Insta_Orient_Spherical Class

TABLE 8

| class compr_ith_insta_orient_spherical { | Num. of bits | Descriptor |
|---|---|---|
| compr_ith_insta_orient_alpha | bit_num_orient_alpha( ) | f(bit_num_orient_alpha( )) |
| compr_ith_insta_orient_beta | bit_num_orient_beta( ) | f(bit_num_orient_beta( )) |
| compr_ith_insta_orient_gamma | bit_num_orient_gamma( ) | f(bit_num_orient_gamma( ) |
| if (need_correction( )) { | | |
| compr_ith_insta_orient_res | 6*bit_num_orient_res_cartesian( ) | f(6*bit_num_orient_res_cartesian( )) |
| } | | |
| } | | |

The orientation of ith instance in spherical mode is represented by 3 angles, alpha, beta & gamma.
compr_ith_insta_orient_alpha: contains the compressed alpha of ith instance's orientation.
compr_ith_insta_orient_beta: contains the compressed beta of ith instance's orientation.
compr_ith_insta_orient_gamma: contains the compressed gamma of ith instance's orientation.
compr_ith_insta_orient_res: contains the compressed residual in Cartesian coordinate system of ith instance's orientation.
bit_num_orient_alpha( ): compute the number of bits for each alpha value based on QP
bit_num_orient_beta( ): compute the number of bits for each beta value based on QP
bit_num_orient_gamma( ): compute the number of bits for each gamma value based on QP
need_correction( ): check the orientation, if it is in the edge condition which probably results in a large error, return true; otherwise, return false.

### Compr_Insta_Separate_Data Class

TABLE 9

| | Num. | |
|---|---|---|
| class compr_insta_data_separate{ | of bits | Descriptor |
| compr_insta_patternID_length | 32 | |
| compr_insta_patternID_data | | ec(v) |
| compr_insta_position_length | 32 | |
| compr_insta_position_data | | |
| compr_insta_orient_length | 32 | |
| compr_insta_orient_data | | |
| if (use_scaling_bit){ | | |
| compr_insta_scaling_length | 32 | |
| compr_insta_scaling_data | | ec(v) |
| } | | |
| } | | |

compr_insta_patternID_length: contains a 32-bit unsigned integer indicating the length of the compressed pattern ID of all instances.
compr_insta_patternID_data: contains the compressed pattern IDs of all instances.
compr_insta_position_length: contains a 32-bit unsigned integer indicating the length of the compressed position of all instances.
compr_insta_position_data: contains the compressed positions of all instances.
compr_insta_orient_length: contains a 32-bit unsigned integer indicating the length of the compressed orientation of all instances.
compr_insta_orient_data: contains the compressed orientation of all instances.
compr_insta_scaling_length: contains a 32-bit unsigned integer indicating the length of the compressed scaling factors of all instances.
compr_insta_scaling_data: contains the compressed scaling factors of all instances.

### Compr_Ins_Position_Data Class

TAB. 10

| | Num. | |
|---|---|---|
| class compr_insta_position_data{ | of bits | Descriptor |
| insta_position_bbox | 6 * 32 | |
| config_n0_symbols | | ec(v_n0) |
| config_n1_symbols | | ec(v_n1) |
| config_n2_symbols | | ec(v_n2) |
| } | | |

insta_position_bbox: contains the bounding box of all instance positions.
config_n0_symbols: contains n0 ordinary octree configuration symbols.
config_n1_symbols: contains n1 ordinary octree configuration symbols.
config_n2_symbols: contains n2 ordinary octree configuration symbols.

### Compr_Insta_Orient_Data Class

TABLE 11

| class compr_insta_orient_data { | Num. of bits | Descriptor |
|---|---|---|
| If (insta_orient_mode_bit == 1){ | | |
| for (i = 0; i < numofInstance; i ++) { | | |
| compr_ith_insta_orient_cartesian | | |
| } | | |
| } | | |
| else{ | | |
| for (i = 0; i < numofInstance; i ++) { | | |
| compr_ith_insta_orient_spherical | | |
| } | | |
| } | | |
| } | | |

Additionally, the bitstream described above may also be embedded in other bitstreams such as the SC3DMC bitstream defined by MPEG-3DGC [w11455]. Here is a possible embodiment of that solution.

We use the ISO reserved value 3 of encodingMode of SC3DMCStreamHeader as follows (Ref. to the original Table 53 of [w11455]).

TABLE 12
Table 1 - SC3DMC encoding modes

| | encodingMode | Method |
|---|---|---|
| | 0 | QBCR |
| | 1 | SVA |
| | 2 | TFAN |
| → | 3 | A3DMC |
| | 4-255 | ISO reserved |

We revise SC3DMCStream defined in [w11455] as follows.

TABLE 13

| Class SC3DMCStream{ | Num. of bits | Descriptor |
|---|---|---|
| SC3DMCStreamHeader; | | |
| If(header.encodingMode == 3){ | | |
| A3DMC_stream_header_SC3DMC; | | |
| compr_repeat_struc_data | | |
| } | | |
| else{ | | |
| SC3DMCStreamData data; | | |
| } | | |
| } | | |

### A3DMC_Stream_Header_SC3DMC Class

TABLE 14

| class A3DMC_stream_header{ | Num. of Bits | Descriptor |
|---|---|---|
| 3d_model_compr_mode | 2 | |
| QP | 5 | |
| reserved_bits_first | 1 | |
| pattern_num | 8 | |
| If(pattern_num == 255){ | | |
| pattern_num_2 | 16 | |
| } | | |
| instance_num | 16 | |
| If(instance_num == 65535){ | | |
| instance_num_2 | 32 | |
| } | | |
| insta_trans_separate_bit | 1 | |
| insta_orient_mode_bit | 1 | cartesian / spherical |
| | | coordinate |
| use_scaling_bit | 1 | |
| uni_part_bit | 1 | |
| reserved_bits | 4 | |
| } | | |

reserved_bits_first: a 1 bit unsigned integer which is always 0. It is for byte alignment.

In particular, the invention relates to
1. The compressed bitstream syntax and semantics of our repetitive structure discovery based compression algorithm
2. The solution to have separate instance or grouped instance transformation data options both possible in the bitstream.
3. Possible embodiment of our current bitstream proposal in existing SC3DMC bitstream.

FIG. 3 depicts a block diagram of an exemplary 3D model encoder 300. The input of apparatus 300 may include a 3D model, quality parameter for encoding the 3D model and other metadata. The 3D model first goes through the repetitive structure discovery module 310, which outputs the 3D model in terms of patterns, instances and unique components. A pattern encoder 320 is employed to compress the patterns and a unique component encoder 350 is employed to encode the unique components. For the instances, the instance component information is encoded based on a user-selected mode. If instance information group mode is selected, the instance information is encoded using grouped instance information encoder 340; otherwise, it is encoded using an elementary instance information encoder 330. The encoded components are further verified in the repetitive structure verifier 360. If an encoded component does not meet its quality requirement, it will be encoded using unique component encoder 350. Bitstreams for patterns, instances, and unique components are assembled at bitstream assembler 370.

FIG. 4 depicts a block diagram of an exemplary 3D model decoder 400. The input of apparatus 400 may include a bitstream of a 3D model, for example, a bitstream generated by encoder 300. The information related to patterns in the compressed bitstream is decoded by pattern decoder 420. Information related to unique components is decoded by unique component decoder 450. The decoding of the instance information also depends on the user-selected mode. If instance information group mode is selected, the instance information is decoded using a grouped instance information decoder 440; otherwise, it is decoded using an elementary instance information decoder 430. The decoded patterns, instance information and unique components are reconstructed to generate an output 3D model at model reconstruction module 460.

The implementations described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation” of the present principles, as well as other variations thereof, mean that a particular feature, structure, characteristic, and so forth described in connection with the embodiment is included in at least one embodiment of the present principles. Thus, the appearances of the phrase “in one embodiment” or “in an embodiment” or “in one implementation” or “in an implementation”, as well any other variations, appearing in various places throughout the specification are not necessarily all referring to the same embodiment.

As will be evident to one of skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

In principle, the disclosed invention can also be applied to other data compression areas. The invention results in a unique bitstream format.

While the bitstream embeds all the transformation data, it is efficient and may address several applications, where sometimes either bitstream size or decoding efficiency or error resilience matters the most. Therefore, two mode options are disclosed for how to put the transformation data of one instance, i.e. its position, orientation and scaling factor, in the bitstream. In the first mode (Option A), the position, orientation and possible scaling factor of one instance are packed together in the bitstream. In the second mode (Option B), the positions, orientations or possible scaling factors of all instances are packed together in the bitstream.

It will be understood that the present invention has been described purely by way of example, and modifications of detail can be made without departing from the scope of the invention.

Each feature disclosed in the description and (where appropriate) the claims and drawings may be provided independently or in any appropriate combination. Features may, where appropriate be implemented in hardware, software, or a combination of the two. Connections may, where applicable, be implemented as wireless connections or wired, not necessarily direct or dedicated, connections. Reference numerals appearing in the claims are by way of illustration only and shall have no limiting effect on the scope of the claims.

### CITED REFERENCES

[PA090039] Kangying Cai, J. Yu and Z. B. Chen, “EFFICIENT COMPRESSION SCHEME FOR LARGE 3D ENGINEERING MODELS”, International Patent Application No. PCT/EP2010/058048, published as W02010/149492A1 (internal reference PA090039)
[CAI2009] Kangying Cai, Wencheng Wang, Zhibo Chen, Quqing Chen and Jun Teng, “Exploiting Repeated Patterns for Efficient Compression of Massive Models”, VRCAI2009.
[w11455] Final text of ISO/IEC 14496-16 4^{th} Edition, MPEG-3DGC, 93th MPEG meeting

1. A method for encoding or decoding a bitstream representing a 3D model, comprising the steps of:
accessing a plurality of instance information associated with the 3D model, each instance being associated with a corresponding pattern and transformation data;
encoding, or decoding, the plurality of instance information for transmission in a bitstream in one of first and second modes, wherein in the first mode, the transformation information associated with each respective instance is grouped in the bitstream with the respective instance on an instance by instance basis, and in the second mode, the transformation information is grouped in the bitstream on a transformation information type by transformation type basis.

2. The method of claim 1, further including the step of using an indicator bit to determining whether the instance information is grouped in the first mode or in the second mode.

3. The method of claim 2, wherein the type of transformation data includes one or more of position, orientation and scaling factor data.

4. The method of claim 3, further comprising the step of encoding, or decoding, data related to a unique part of the 3D model following the instance information.

5. The method of claim 3, wherein the bitstream is encoded, or decoded, using an adaptive combination of the first and second modes, wherein selected ones of the instance information are encoded, or decoded, using the first mode, and selected others of the instance information are encoded, or decoded, using the second mode.

6. An encoder for encoding a bitstream representing a 3D model, comprising:
module for discovering repetitive structure in the 3D model including patterns, and instances associated with respective patterns and transformation data;
module for encoding instance information in a bitstream in one of first and second modes, wherein in the first mode, the transformation information associated with each respective instance is grouped in the bitstream with the respective instance on an instance by instance basis, and in the second mode, the transformation information is grouped in the bitstream on a transformation information type by transformation information type basis.

7. The encoder of claim 6, wherein the module for encoding includes an indicator bit for determining whether the instance information is grouped in the first mode or in the second mode.

8. The encoder of claim 7, wherein the type of transformation data includes one or more of position, orientation and scaling factor data.

9. The encoder of claim 8, wherein the module for encoding further includes data related to a unique part of the 3D model following the instance information.

10. The encoder of claim 8, wherein the module for encoding encodes the bitstream using an adaptive combination of the first and second modes, wherein selected ones of the instance information are encoded, or decoded, using the first mode, and selected others of the instance information are encoded, or decoded, using the second mode.

11. A decoder for decoding a bitstream representing a 3D model, comprising:
module for accessing a bitstream including instance information associated with corresponding patterns and transformation data;
module for decoding the instance information in a bitstream in one of first and second modes, wherein in the first mode, the transformation information associated with each respective instance is grouped in the bitstream with the respective instance on an instance by instance basis, and in the second mode, the transformation information is grouped in the bitstream on a transformation information type by transformation information type basis.

12. The decoder of claim 11, wherein the module for decoding determines on the basis of an indicator bit whether the instance information is grouped in the first mode or in the second mode.

13. The decoder of claim 12, wherein the type of transformation data includes position, orientation and scaling factor data.

14. The decoder of claim 13, wherein the module for decoding further decodes data related to a unique part of the 3D model following the instance information.

15. The decoder of claim 13, wherein the module for decoding decodes the bitstream using an adaptive combination of the first and second modes, wherein selected ones of the instance information are encoded, or decoded, using the first mode, and selected others of the instance information are encoded, or decoded, using the second mode.

16. A bitstream representing a 3D model stored in a tangible medium, comprising:
instance information associated with corresponding patterns and transformation data;
the instance information being included with the bitstream in one of first and second modes, wherein in the first mode, the transformation information associated with each respective instance is grouped in the bitstream with the respective instance on an instance by instance basis, and in the second mode, the transformation information is grouped in the bitstream on a transformation information type by transformation information type basis.

17. The bitstream of claim 16, wherein the bitstream includes an indicator bit that indicates whether the instance information is grouped in the first mode or in the second mode.

18. The bitstream of claim 17, wherein the type of transformation data includes position, orientation and scaling factor data.

19. The bitstream of claim 18, wherein the bitstream further includes data related to a unique part of the 3D model following the instance information.

20. The bitstream of claim 18, wherein the bitstream includes an adaptive combination of the first and second modes, wherein selected ones of the instance information are encoded, or decoded, using the first mode, and selected others of the instance information are encoded, or decoded, using the second mode.
